(19) United States
(12) Patent Application Publication
(10) Pub. No.: US 2009/0110476 A1
(43) Pub. Date: Apr. 30, 2009

(54) Snap ring securing mechanism on a shaft/hub connection

(75) Inventor: Bernd Patzelt, Magdeburg (DE)

Correspondence Address: COLLARD & ROE, P.C., 1077 NORTHERN BOULEVARD, ROSLYN, NY, 11576, US

(73) Assignee: IFA-Technologies GmbH

(21) Appl. No.: 12/288,800

(22) Filed: Oct. 23, 2008

(30) Foreign Application Priority Data
Oct. 27, 2007 (DE) 20 2007 014 997.2

(51) Int. Cl. F16B 21/00

(52) U.S. Cl. 403/326

(57) ABSTRACT

A snap ring securing mechanism on a shaft/hub connection, for axial support of a shaft and hub that rotate with one another, has a snap ring that is inserted into ring grooves of the shaft journal and hub. The side surfaces of the ring groove of the hub are configured at a specific bevel angle, giving the ring groove a trapezoid cross-section. The ring groove of the hub as a depth dimension that is greater than half the thickness of the snap ring, thereby forming a tilt edge at the parting join of the shaft journal and hub. In the joined state of the shaft and hub, the snap ring is disposed in the ring grooves of the shaft journal and of the hub.

### CROSS REFERENCE TO RELATED APPLICATIONS

Applicant claims priority under 35 U.S.C. 119 of German Application No. 20 2007 014 997.2 filed Oct. 27, 2007.

### BACKGROUND OF THE INVENTION

1. Field of the Invention

The invention relates to a snap ring securing mechanism on a shaft/hub connection, the securing mechanism having components being displaced against one another to form a firm connection between shaft and hub. One of the components has a bore in which the other component is accommodated. The two components are mounted to each other by being pushed on or in, respectively, and secured to prevent displacement, at least counter to the pushing-on or pushing-in direction, by a snap ring pre-assembled into a groove in one of the components. The snap ring has radial resilience and is moved into a groove of the other component during assembly, when it reaches this groove.

2. The Prior Art

Such shaft/hub connections are used in many ways, particularly in the automotive sector, for example in order to connect shafts and hubs of cardan shafts. A significant factor in the configuration of such shaft/hub connections is that they are appropriately secured against axial displacement, and that they are not subject to destruction, even under significant axial forces.

The problems in configuring and securing shaft/hub connections lie in the requirement that these hub/shaft connections can be formed without excessive expenditure of force, and, for another, that a shaft/hub connection configured in this manner sufficiently withstands the operating conditions, which means that the snap ring used to secure the shaft/hub connection withstands even great operating stresses, and thus assures reliable functioning of such shaft/hub connections.

A snap ring securing mechanism on a shaft/hub connection, particularly on a shaft/hub connection that rotates rapidly or is subject to impact stress, is described in German Patent Application No. DE 25 08 677. In this document, two snap rings are used, one snap ring of which is supposed to guarantee a securing mechanism for the other snap ring. The first snap ring is disposed, radially on the inside, only in the shaft groove, and the second snap ring is disposed, radially on the outside, only in the hub groove, so that the shaft groove is structured to be so deep that the first snap ring can submerge into the shaft groove by the depth of the hub groove when the second snap ring is introduced.

The large technical effort for forming the snap ring securing mechanism is a disadvantage in this solution, since the two snap rings that are used must be positioned precisely, relative to one another, when they are inserted, in order to achieve the required reliable functioning.

Another axial securing mechanism for two components that can be displaced axially, relative to one another, has become known from German Patent No. DE 40 40 337 C2. In this device, one component has a bore in which the other component is accommodated. The two components are assembled by being pushed on or in, respectively, and secured to prevent displacement, at least counter to the pushing-on or pushing-in direction, by means of a snap ring pre-assembled into a groove of one of the components. The snap ring has radial resilience and is moved into a groove of the other component during assembly, when it reaches this groove. The groove in which the snap ring is held in pre-assembled manner is structured as a separate pre-assembly groove having a conical assembly surface, out of which the snap ring projects with at least half of its thickness, beyond the seating surface of the components, radially, towards the other component. The clamping surfaces serve as assembly surfaces, and are supposed to facilitate joining of the components to be connected, and also to bring about axial securing.

Since the snap ring used in such axial securing mechanisms is not closed, but rather has a gap that extends in the circumference direction, it can therefore be changed, in its outside or inside diameter, by elastic deformation. Conventional securing of the snap ring in a groove takes place solely by means of spring tension. However, under certain operating conditions, spring tension is not sufficient to hold the snap ring in its groove. Instead, what can happen is that the snap ring exits from its groove, and therefore can no longer perform its function of axial fixation, which means that this leads to sensitive and extensive damage cases.

### SUMMARY OF THE INVENTION

It is therefore an object of the invention to create a snap ring securing mechanism on a permanent, difficult-to-loosen shaft/hub connection, by means of which exiting of the snap ring from the ring groove is prevented, while eliminating the disadvantages of the known solutions, and at a reasonable cost expenditure.

According to the invention, this object is accomplished by a snap ring securing mechanism on a shaft/hub connection in which the shaft, configured with a shaft journal, and the hub are configured in known manner, on their outer circumference, i.e. in their bore, with a profile gear mechanism, i.e., spline, by way of which both a force-fit and a shape-fit connection is created when shaft and hub are joined together. This connection is additionally secured to prevent axial displacement of the joined parts, by means of a snap ring securing mechanism.

To accommodate the snap rings, the hub and also the shaft journal of the shaft are configured with grooves in which the snap ring finds accommodation, as a securing element. The two side surfaces of the groove of the hub are configured at a specific bevel angle, and thus give the groove in the hub a trapezoid cross-sectional shape.

The side surfaces of the groove in the hub run in such a manner that they run towards the bottom of the groove at an outside slant, so that the bottom of the groove possesses a greater width relative to the width at the parting join of hub and shaft journal.

The depth of the groove in the hub is greater than half the thickness dimension of the snap ring. When using a snap ring having a circular cross-section, the depth dimension is therefore greater than the radius of the circular cross-section of the snap ring.

With this arrangement and configuration of the snap ring securing mechanism, it is guaranteed that in the final state of the hub/shaft connection, the snap ring is secured deeper in the groove of the hub as compared with the groove in the shaft journal. This is where the significant advantage of the snap ring securing mechanism being presented comes to bear; it assures that under all operating conditions, the snap ring cannot exit from the groove of the hub, so that sufficient axial securing of a shaft/hub connection is given.

The snap ring securing mechanism of the invention can be used in shaft/hub connections in which the shaft is configured with a shaft journal integrally formed by mechanical processing of the shaft, or in which the shaft journal is produced as a separate component and then firmly connected with the shaft, in order to connect the shaft with a hub.

The profile gear mechanisms (splines) with which the bore of the hub and the outer circumference of the shaft journal are configured can be structured in many different forms. Preferably, a notch gear mechanism should be used, this in turn taking into consideration expenditure in terms of production technology and economics.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a shaft/hub connection, partly in section;

FIG. 1a shows a cross-sectional view along lines I-I of FIG. 1; and

FIG. 2 shows an enlarged view A according to FIG. 1.

### DETAILED DESCRIPTION OF THE PREFERRED EMBODIMENT

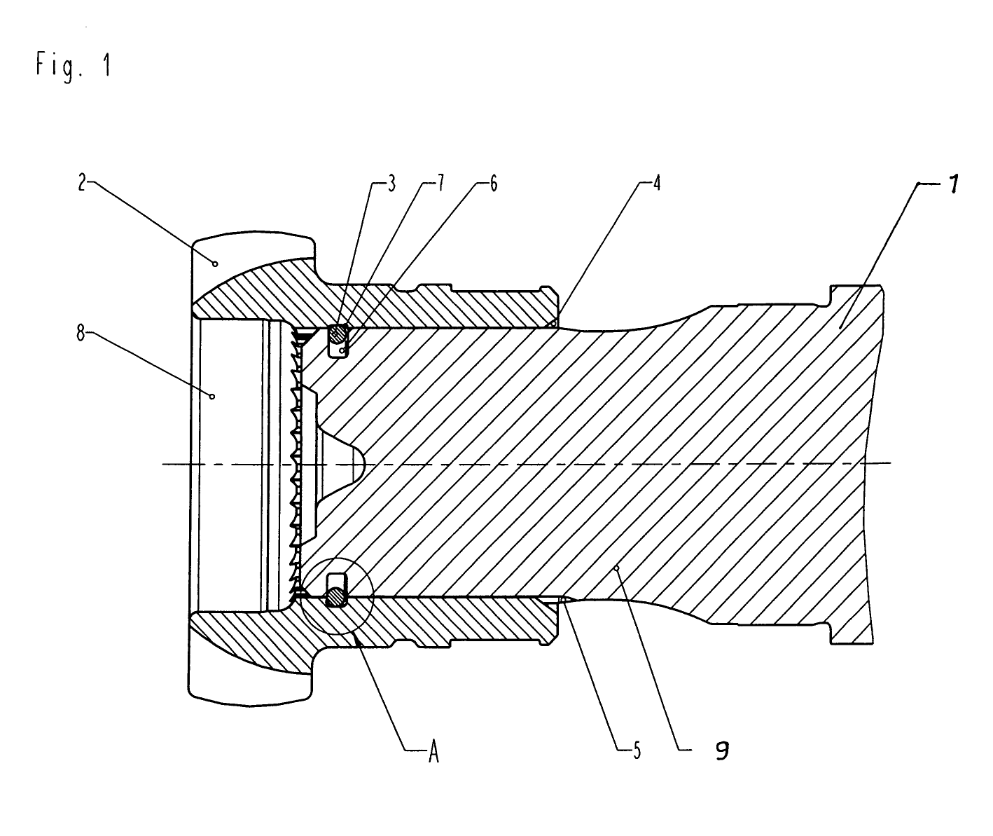

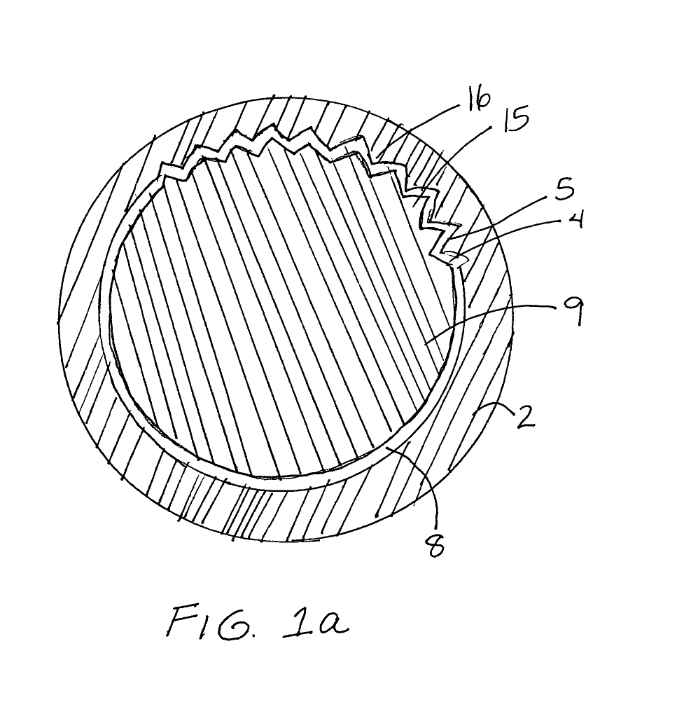

Referring now in detail to the drawings and, in particular, FIG. 1, a shaft/hub connection is shown, for example a connection of a cardan shaft with the hub of a joint.

As shown in FIG. 1, shaft 1 can be integrally configured with a shaft journal by means of mechanical processing, or the shaft journal 9 is a separate component that is then firmly connected with the shaft 1.

The outer circumference of shaft journal 9 is configured with an outer profile 5. Hub 2 possesses a centric bore 8, into which an inner profile 4 is worked, and, in this connection, is adapted to outer profile 5, so that the two parts, shaft 1 and hub 2, can be joined with one another, thereby producing a force-fit and shape-fit connection. As shown in FIG. 1a, the outer and inner profiles are configured with notches 15, 16 to form a notch gear mechanism.

Shaft journal 9 and hub 2 are configured with ring grooves 6; 7, in which snap ring 3 is accommodated to ensure axial securing of the connection between shaft 1 and hub 2.

When the connection between shaft 1 and hub 2 is to be produced, a commercially available snap ring 3 is inserted into the ring groove of shaft journal 9. Hub 2 is then set onto shaft journal 9, so that inner profile 4 and outer profile 5 stand relative to one another in such a way that the elevations of the one profile engage into depressions of the other profile. There are bevels 13, 14 at the face of shaft journal 3 and the face of bore 8 of hub 2, which facilitate the joining of shaft 1 and hub 2, and also act as guides.

Of course, this assembly process can also be structured so that the hub 2 is set onto the shaft journal 9 of shaft 1, and positioned relative to it.

When ring groove 6 of shaft journal 9 and ring groove 7 of hub 2 attain the same axial position, with equal coverage, the biased snap ring 3 springs apart, in the broadest sense, and comes to rest in the bottom of ring groove 7 of hub 2 with its outer circumference.

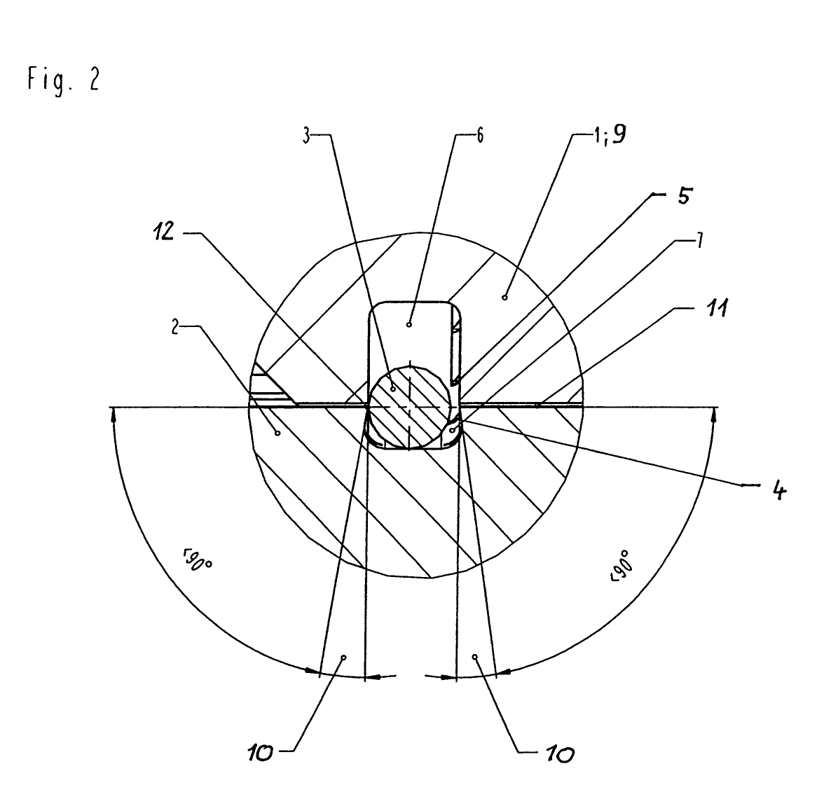

This position of snap ring 3 is shown in FIG. 2, in the enlarged representation. FIG. 2 shows the shape of ring groove 7 of hub 2, and the end position of snap ring 3 when shaft 1/shaft journal 9 and hub 2 are joined with one another.

Ring groove 7 is configured in a trapezoid form, in that the side surfaces of ring groove 7 are structured to be wider towards the bottom of the groove, at a specific bevel angle 10, from which it is also evident how snap ring 3 is mounted in ring grooves 6; 7.

As a result of the configuration of ring groove 7 with a depth dimension that is greater than half the thickness dimension of snap ring 3, snap ring 3 is set into ring groove 7 in such a manner that a tilt edge 12 results at parting join 11 of shaft journal 9 and hub 2, in the broadest sense, which edge ensures that under axial stress on the hub/shaft connection, the inserted snap ring 3 is not pushed out of ring grooves 6; 7, and this tilt edge 12 brings about additional securing of the position of inserted snap ring 3.

Bevel angles 10 are configured with an angle dimension of greater than 1°; preferably these bevel angles 10 have an incline dimension of 1 to 10°. As explained above, the depth dimension of the ring groove 7 is greater than half the thickness dimension of snap ring 3. The dimension differences result from the dimensions of shaft 1 or shaft journal 9 and hub 2, and the thickness dimension of snap ring 3.

The difference between the depth dimension of ring groove 7 and the thickness dimension of snap ring 3 lies in the millimeter range. When using a snap ring 3 having a circular cross-section and a diameter of 2 mm, for example, the difference is 0.2 to 0.8 mm. This dimension difference therefore corresponds to the maximum dimension of tilt edge 12.

Accordingly, while only a few embodiments of the present invention have been shown and described, it is obvious that many changes and modifications may be made thereunto without departing from the spirit and scope of the invention.

What is claimed is:

1. A snap ring securing mechanism for securing a shaft and a hub to one another, comprising:
a ring groove on a shaft journal of the shaft;
a ring groove on the hub; and
a snap ring that is inserted into the ring grooves of the shaft journal and hub in a joined state of the shaft and hub,
wherein side surfaces of the ring groove of the hub are configured at a bevel angle so that the ring groove of the hub has a trapezoidal cross-section, said ring groove of the hub having a depth that is greater than half of a thickness of the snap ring, thereby forming a tilt edge at a parting join of shaft journal and hub.

2. The snap ring securing mechanism according to claim 1, wherein the bevel angles of the side surfaces of the ring groove of the hub are greater than 1°.

3. The snap ring securing mechanism according to claim 1, wherein the tilt edge has a height of between 0.2 mm to 0.8 mm, relative to a progression of the parting join.

4. The snap ring securing mechanism according to claim 1, wherein the hub has a bore with an inner profile, and the shaft journal has an outer profile, the inner and outer profiles being configured as a notch gear mechanism, so that in the joined state of shaft and hub, a force-fit and shape-fit connection is produced.

5. The snap ring securing mechanism according to claim 4, wherein the outer profile of the shaft journal and the inner profile of the bore of the hub are each configured with guide bevels.

6. The snap ring securing mechanism according to claim 1, wherein the shaft journal is firmly connected with the shaft, such that the shaft journal is structured as a separate component or is integrally formed with the shaft by mechanical processing of the shaft.
